(19) United States
(12) Patent Application Publication
(10) Pub. No.: US 2010/0077649 A1
(43) Pub. Date: Apr. 1, 2010

(54) FISHING ROD WITH REAL FISH SKIN ADORNMENT AND METHOD OF MAKING

(76) Inventor: Michael J. Giacobbe, Cranston, RI (US)

Correspondence Address: CLARK & BRODY, 1090 VERMONT AVENUE, NW, SUITE 250, WASHINGTON, DC, 20005, US

(21) Appl. No.: 12/565,292

(22) Filed: Sep. 23, 2009

Related U.S. Application Data
(60) Provisional application No. 61/136,707, filed on Sep. 26, 2008.

(51) Int. Cl. A01K 87/00; A22C 25/17

(52) U.S. Cl. 43/25; 452/125

(57) ABSTRACT

A fishing rod includes a real fish skin adornment surrounding at least a portion of the fishing rod blank. The fish skin can be any fish skin and is made pliable so that it can be wrapped around the blank. The skin is then adhered to the blank using a clear coating so that the skin is protected from the elements but still visible to enhance the look of the fishing rod.

This application claims priority under 35 USC 119(e) based on application no. 61/136,707 filed on Sep. 26, 2008.

### TECHNICAL FIELD

The present invention is directed to an improved fishing rod that has a real fish skin adornment and a method of making such a rod.

### BACKGROUND ART

Fishing rods come in a wide variety of shapes, sizes, and styles. Most rods are utilitarian in design, focusing on functionality in terms of the materials, guides, etc. These rods are lacking in features that attract prospective customers as well provide a focal point once the rods are sold to generate repeat business. Consequently, there is a need for improvements in the adornments associated with fishing rods to improve the marketability and sales of the rods.

The present invention responds to this need by providing a unique fishing rod that includes real fish skin adornment.

### SUMMARY OF THE INVENTION

One object of the invention is to provide an improved fishing rod.

Another object of the invention is to provide a fishing rod that includes real fish skin on the rod.

Yet a further object of the invention is a method of making a fishing rod with a real fish skin adornment.

Other objects and advantages of the invention will become apparent based on the description below.

### BRIEF DESCRIPTION OF THE DRAWINGS

FIG. 1 is one embodiment of the invention showing a portion of a fishing rod with the real fish skin adornment.

FIG. 2 shows the fishing rod of FIG. 1 with its handle end. FIG. 3 is another view of the entire fishing rod of FIG. 1.

### DESCRIPTION OF THE PREFERRED EMBODIMENTS

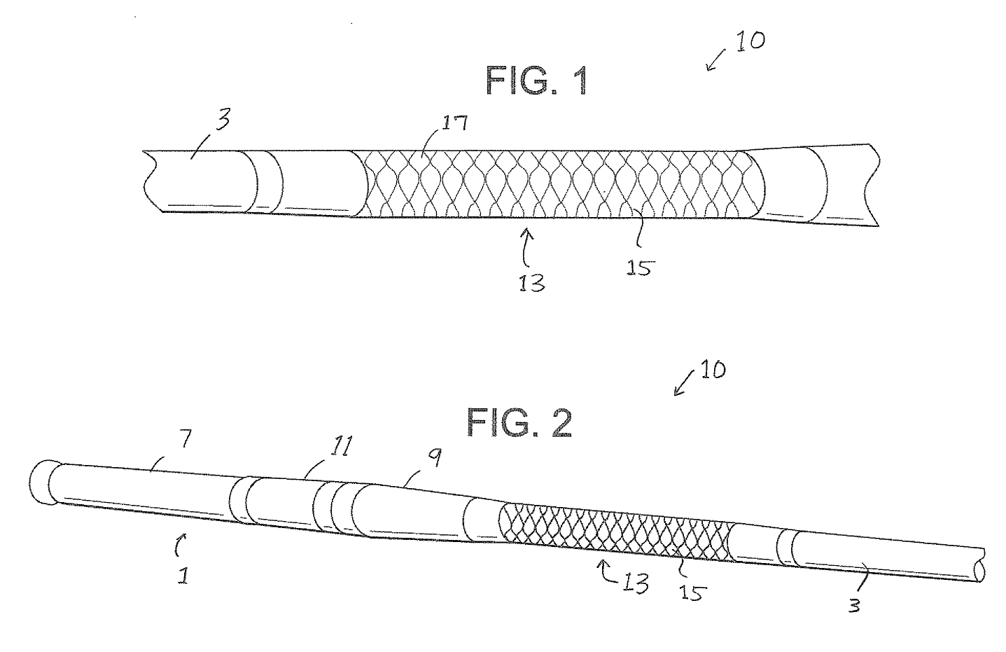

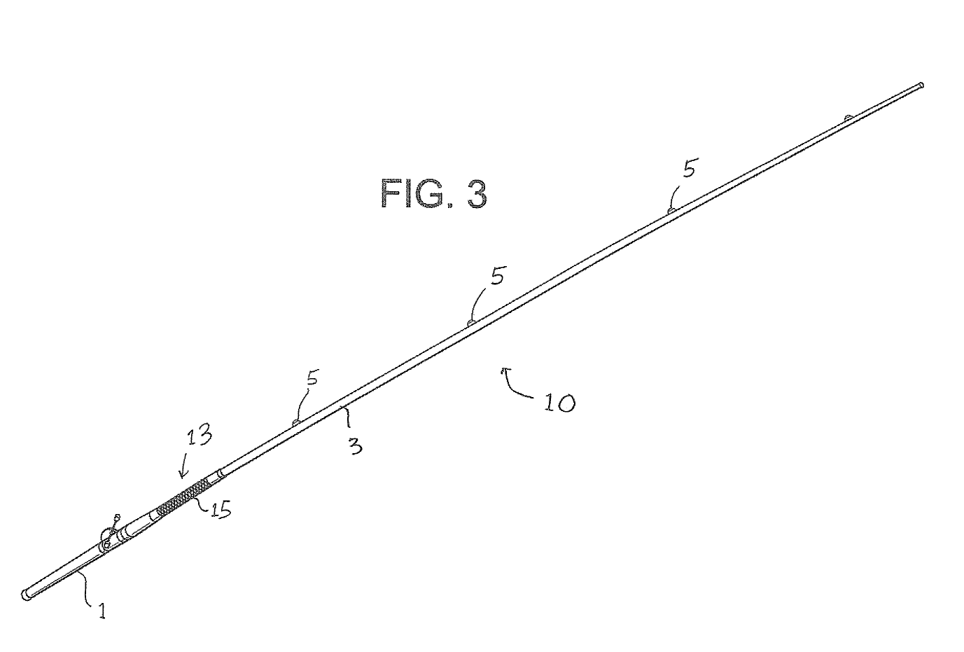

Referring now to FIGS. 1-3, the fishing rod is designated by the reference numeral 10 and includes a handle end 1, a blank 3, and a number of guides 5 for guiding fishing line during use. The handle end is shown with two sections 7 and 9, each separated by a section 11 designed to support a reel (not shown).

In the Figures, the fishing rod 10 is shown with a section of the blank having an adornment 13. The adornment comprises a real fish skin 15, which is coated with a protective coating 17 to protect it from the elements, such as water, sunlight, oils, etc. While the Figures show one adornment, more than one part of the blank can be covered with an actual fish skin. This skin gives the rod a more pleasing appearance, and enlists fisherman to select the fish skin-containing rods over other competing rods.

The fishing rod 10 can be any type and the fish skin can be placed in one or more areas of the blank of the rod.

In essence, the fishing rod has its blank with a fish skin wrapped around its exterior and is coated with a clear-coat liquid hardening solution to protect the skin and rod from damage while allowing the fish skin to be seen.

Any legal fish skin can be used with the rod, e.g., sea bass, blue fish, herring, tuna, shark, mackerel, Hook, flounder, sea robin, etc., with skin that has a more scaly pattern such as bass preferred since the scales on the fishing rod stand out more.

One method of making the fish skin-wrapped rod is as follows:

1) The skin of any legal fish are filleted or cut off the fish.

2) A brush or a high-power pressure washer or any other means of cleaning meat residue off skin can be used to clean the meat off the inside. Other means as would be known in the art can be used to separate the meat from the skin.

3) After the skins are cleaned, they are soaked for period of time to make the skins soft and pliable. While the time may vary, a soaking time of 24 hours is sufficient for bass skin. Any liquid can be used that will make the skins pliable can be used for the soaking step. One example is a Borax solution.

4) Once the skin is made supple and pliable, the skin is cut to fit around the blank shaft. It is then wrapped around the shaft, with the ends normally butting against each other, although an overlap can occur.

5) Once the skins are known to be properly fitted to the rod blank, the skins are then completely dried. Drying can be done using any technique, ambient air drying, oven drying, forced heated or unheated air drying and the like.

6) Once dried, the underside of the skin can be coated with an adhesive and/or the blank is coated with an adhesive and the fish skin is again placed around the blank shaft to be adhered thereto.

7) At this point the skin is coated with epoxy (UV or non-UV) or any type of clear coat resin or varnish, polyester or glue to coat and protect the skin. Optionally, the epoxy or clear coat hardening solution can be used to both coat and protect the skin and adhere it to the blank. UV containing epoxy clear coat compositions are preferred given the fact that the fishing rods will be exposed to sunlight.

8) The coating is left to fully dry.

9) Optionally, the skin can be recoated with the epoxy clear coat or other clear coating composition and dried completely. The use of the UV blocker-containing clear coat hardening material helps protect the skin from both the sun's harmful UV rays and wear and tear over time while leaving the fish skin visible to enhance the look of the fishing rod.

In the event that supply of real fish skin becomes scarce, a synthetic fish skin can be substituted for the real skin. In this embodiment, it may only be necessary to size the skin to fit the rod being covered since the synthetic skin may already be made in a pliable form. Thus, the steps of making the real fish skin pliable could be bypassed when using the synthetic fish skin. Of course, real fish skin is preferred since it provides a real three dimensional look, which may not be the case for a synthetic fish skin.

As such, an invention has been disclosed in terms of preferred embodiments thereof which fulfills each and every one of the objects of the present invention as set forth above and provides a new and improved fishing rod and method of making.

Of course, various changes, modifications and alterations from the teachings of the present invention may be contemplated by those skilled in the art without departing from the intended spirit and scope thereof. It is intended that the present invention only be limited by the terms of the appended claims

I claim:

1. A method of adhering real fish skin to a fishing rod blank comprising:
a) separating fish meat from a fish skin;
b) soaking the fish skin to make it pliable;
c) cut the fish skin to length to fit around the rod blank;
d) drying the fish skin;
e) adhering the fish skin to the fishing rod blank;
f) applying a clear coating on the fish skin to at least protect it from the elements while keeping the fish skin visible.

2. The method of claim 1, wherein the adhering and applying steps are performed simultaneously.

3. The method of claim 1, wherein the fish skin is adhered to a portion of the blank near a handle end of the rod.

4. In a fishing rod having a fishing rod blank, the improvement comprising a visible but coated real fish skin adhered to a portion of the fishing rod blank.

5. The rod of claim 4, wherein the fish skin is adhered to a portion of the fishing rod blank near a handle end of the rod.

6. The rod of claim 4, wherein the fish skin is a bass skin.

7. The rod of claim 4, wherein the fish skin is coated with a coating material that includes one or more UV inhibitors.
